(19) United States
(12) Patent Application Publication
(10) Pub. No.: US 2012/0044272 A1
(43) Pub. Date: Feb. 23, 2012

(54) DISPLAY APPARATUS AND DRIVING METHOD OF DISPLAY PANEL THEREOF

(75) Inventors: Young-ran HAN, Suwon-si (KR); Hye-rin CHOI, Suwon-si (KR); Nam-kyun BEON, Seoul (KR)

(73) Assignee: SAMSUNG ELECTRONICS CO., LTD., Suwon-si (KR)

(21) Appl. No.: 13/175,295

(22) Filed: Jul. 1, 2011

(30) Foreign Application Priority Data
Aug. 19, 2010 (KR) 10-2010-0080380

(51) Int. Cl. G09G 5/10

(52) U.S. Cl. 345/690

(57) ABSTRACT

Disclosed are a display apparatus and a driving method of a display panel thereof, the display apparatus including: a backlight unit which generates and emits light; a display panel which includes a plurality of unit pixels, and displays a first image using the light emitted by the backlight unit; and a panel driver which sets a total number of unit pixel groups including a preset number of unit pixels, from among the plurality of unit pixels, to be different from a total number of pixels of the first image, and selectively drives different unit pixels of a unit pixel group, at different times, to transmit the light therethrough.

### CROSS-REFERENCE TO RELATED APPLICATION

This application claims priority from Korean Patent Application No. 10-2010-0080380, filed on Aug. 19, 2010 in the Korean Intellectual Property Office, the disclosure of which is incorporated herein in its entirety by reference.

### BACKGROUND

1. Field

Apparatuses and methods consistent with the exemplary embodiments relate to a display apparatus which displays an image based on an image signal received from the outside, and a driving method of a display panel thereof, and more particularly, to a display apparatus and a driving method of a display panel thereof which minimize an after image displayed on a display panel if a predetermined image is displayed thereon for a long time.

2. Description of the Related Art

A display apparatus processes an image signal received from the outside to display an image on a display panel based on the processed image signal. The display apparatus may be a TV, a computer monitor for general users, and a digital information display (DID) to provide image information for unspecific users in a public place.

The display apparatus such as the DID tends to fixedly display a specific image, such as a logo, a motto, etc., for a long time according to characteristics of the provided image information. Such a display apparatus employs a liquid crystal display (LCD) panel in general, and if a specific image is displayed on the panel for a long time, a liquid crystal in a location where the image is displayed is stressed. If liquid crystal stress is excessive, the liquid crystal cannot react to an image signal received corresponding to another image, and an after image is generated on the panel. If the after image is generated, the LCD should be replaced, causing massive expenses.

### SUMMARY

According to an aspect of an exemplary embodiment, there is provided: a backlight unit which generates and emits light; a display panel which includes a plurality of unit pixels, and displays a first image using the light emitted by the backlight unit; and a panel driver which sets a total number of unit pixel groups including a preset number of unit pixels, from among the plurality of unit pixels, to be different from a total number of pixels of the first image, and selectively drives different unit pixels of a unit pixel group among the total number of unit pixel groups, at different times, to transmit the light therethrough.

The panel driver may set a number of pixels of a horizontal resolution of the first image to be different from a number of unit pixel groups in a single row of the display panel.

The panel driver may divide and apply a pixel value of the first image to a unit pixel, of the unit pixel group, through which the light is transmitted.

The preset number of unit pixels of the unit pixel group may be even.

The unit pixel group may include a first sub group and a second sub group, and a number of unit pixels in the first and second sub groups may be the same.

The panel driver may alternately drive the first sub group and the second sub group to transmit the light therethrough.

The panel driver may select the different unit pixels, through which the light is transmitted, by field or frame of the first image.

The panel driver may change a degree of light transmittance of the unit pixels by turning on and off the unit pixels, linearly or non-linearly, on a unit time basis.

The panel driver may select the different unit pixels, through which the light is transmitted, for every unit time according to a preset pattern, and may change the preset pattern at a preset interval.

The display panel may not include a color filter, and the backlight unit may sequentially supply light in red, green and blue colors to the display panel.

According to an aspect of another exemplary embodiment, there is provided a driving method of a display panel, the driving method including: receiving an image signal corresponding to a first image; setting a total number of unit pixel groups including a preset number of unit pixels, from among a plurality of unit pixels of the display panel, to be different from a total number of pixels of the first image; and selectively driving different unit pixels of a unit pixel group among the total number of unit pixel groups, at different times, to transmit light therethrough to display the first image.

The setting the unit pixel group may include setting a number of pixels of a horizontal resolution of the first image to be different from a number of unit pixel groups in a single row of the display panel.

The selectively driving the different unit pixels may include dividing and applying a pixel value of the first image to a unit pixel, of the unit pixel group, through which the light is transmitted.

The preset number of unit pixels of the unit pixel group may be even.

The unit pixel group may include a first sub group and a second sub group, and a number of unit pixels in each of the first sub group and the second subgroup may be the same.

The selectively driving the different unit pixels may include alternately driving the first sub group and the second sub group to transmit the light therethrough.

The selectively driving the different unit pixels may include selecting the different unit pixels, through which the light is transmitted, by field or frame of the first image.

The selectively driving the different unit pixels may include changing a degree of light transmittance of the unit pixels by turning on and off the unit pixels, linearly or non-linearly, on a time basis.

The selectively driving the different unit pixels may include selecting the different unit pixels, through which the light is transmitted, for every unit time according to a preset pattern, and changing the preset pattern at a preset interval.

According to an aspect of another exemplary embodiment, there is provided a display apparatus including: a display panel which includes a plurality of unit pixels, and displays a first image using light; and a panel driver which sets a total number of unit pixel groups including a preset number of unit pixels, from among the plurality of unit pixels, to be different from a total number of pixels of the first image, and selectively drives different unit pixels of a unit pixel group among the total number of unit pixel groups, at different times, to transmit the light therethrough.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is an exploded perspective view of a display apparatus according to a first exemplary embodiment;

FIG. 2 is a block diagram of the display apparatus in FIG. 1;

FIG. 3 illustrates image fields displayed by light in each color on a time basis from the display apparatus in FIG. 1;

FIG. 4 illustrates pixels which form a first image in the display apparatus in FIG. 1;

FIG. 5 illustrates a grouping of unit pixels of a display panel of the display apparatus in FIG. 1;

FIG. 6 illustrates a driving method of unit pixels with respect to a single unit pixel group in FIG. 5;

FIG. 7 is a graph which illustrates the driving method of the unit pixels in FIG. 6 with respect to time;

FIG. 8 illustrates a method of applying a pixel value to the unit pixels in the display apparatus in FIG. 1;

FIG. 9 is a graph which illustrates a driving method of unit pixels with respect to time according to a second exemplary embodiment;

FIG. 10 is a graph which illustrates a driving method of unit pixels with respect to time according to a third exemplary embodiment; and

FIG. 11 is a control flowchart of a driving method of a display panel according to a fourth exemplary embodiment.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout. However, it is appreciated that it is not meant to exclude such omitted components from a display apparatus 1 to which the spirit of the exemplary embodiments are applied. Expressions such as “at least one of,” when preceding a list of elements, modify the entire list of elements and do not modify the individual elements of the list.

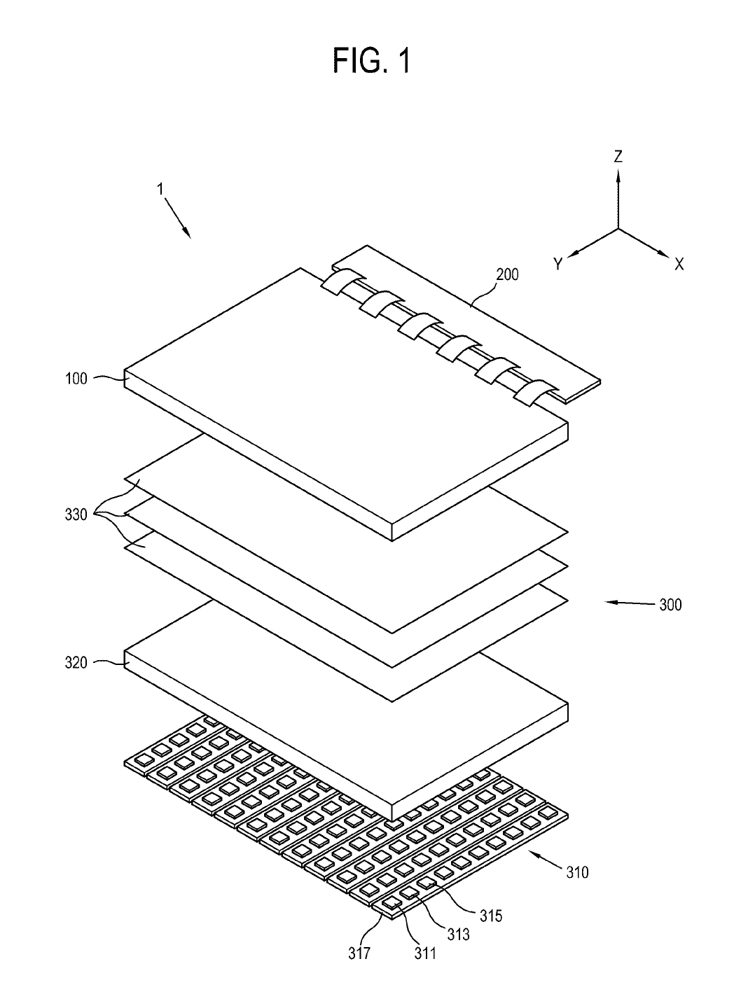

FIG. 1 is an exploded perspective view of a display apparatus 1 according to a first exemplary embodiment. As shown therein, the display apparatus 1 according to the present exemplary embodiment includes a large-screen digital information display (DID). However, the spirit of the present exemplary embodiment is not limited to the foregoing, and may apply to other general display apparatuses as long as they display an image based on an image signal received from the outside.

The display apparatus 1 includes a display panel 100, a panel driver 200 to drive the display panel 100, and a backlight unit 300 to supply light to a rear side of the display panel 100 to thereby display an image on the display panel 100.

According to the present exemplary embodiment, the display panel 100 does not include a color filter, and the backlight unit 300 sequentially emits light in a plurality of colors to the display panel 100, though it is understood that another exemplary embodiment is not limited thereto. An image corresponding to each color is accumulated sequentially within a user's field of view, and thus a user recognizes a final image in combined colors.

Directions in FIG. 1 will now be described. Directions X, Y and Z refer to horizontal, vertical and height directions, respectively. The display panel 100 is disposed along a plane X-Y, and the backlight unit 300 and the display panel 100 are accumulated in the direction Z. Description will be made on the basis of the definition of the above directions. Opposite directions of the directions X, Y and Z refer to directions −X, −Y and −Z, respectively, and the plane X-Y refers to a plane which is formed by axes of the direction X and the direction Y.

The display panel 100 may be a liquid crystal display (LCD) panel according to the present exemplary embodiment, though it is understood that another exemplary embodiment is not limited thereto. As liquid crystals are filled between two substrates (not shown) and the arrangement of such liquid crystals is adjusted by a driving signal applied by the panel driver 200, the display panel 100 displays an image thereon. The display panel 100 does not emit light itself, and receives light from the backlight unit 300 to display an image in a display area. The display area refers to an area that is parallel with the plane X-Y and displays an image therein from the display panel 100.

A plurality of unit pixels (not shown) of the display panel 100 is arranged in a horizontal direction and a vertical direction, i.e., in the directions X and Y, and liquid crystals are provided with respect to each of the unit pixels.

The panel driver 200 includes a printed circuit board (PCB) (not shown) in which a chipset and a wiring are mounted corresponding to various functions. A flexible PCB (not shown) is provided between the PCB and the display panel 100 to transmit a driving signal from the panel driver 200 to the display panel 100.

The panel driver 200 applies a voltage to each of the unit pixels of the display panel 100, to thereby individually rotate liquid crystals of the unit pixels. Furthermore, light transmittance of the unit pixels is controlled differently, and an image is displayed on the display panel 100. A detailed configuration of the panel driver 200 according to the present exemplary embodiment will be described below.

The backlight unit 300 sequentially generates and emits, to the display panel 100, light in a plurality of colors, e.g., RGB colors. The backlight unit 300 includes a light source module 310 which generates light in RGB colors, a light guiding plate 320 which is disposed in parallel with the display panel 100 and receives light from the light source module 310, and an optical sheet 330 which is provided between the light guiding plate 320 and the display panel 100.

According to the present exemplary embodiment, the light source module 310 is a direct type that is arranged below the light guiding plate 320 to be in parallel therewith, but the spirit of the present exemplary embodiment is not limited to the foregoing. The spirit of the present exemplary embodiment may apply to an edge type light source module that is arranged in an edge of the light guiding plate to be in parallel therewith.

The light source module 310 includes a plurality of light sources 311, 313 and 315 which is arranged below the light guiding plate 320 to be in parallel therewith, and a light source substrate 317 in which the plurality of light sources 311, 313 and 315 is mounted.

The light sources 311, 313 and 315 include light emitting diodes (LED), and receive a driving power signal and a lighting control signal from the light source substrate 317. In the present exemplary embodiment, the light sources 311, 313 and 315 include a red LED 311, a green LED 313 and a blue LED 315.

The light source substrate 317 supplies driving power to the light sources 311, 313, and 315 mounted in an upper surface by being connected to an additional power source (not shown). The light sources 311, 313 and 315 in the light source substrate 317, i.e., the red LED 311, the green LED 313 and the blue LED 315, are selectively turned on/off according to a control of a light source driver 400 (to be described below).

The light guiding plate 320 may be a plastic mold lens including acryl, and uniformly transmits the light from the light source module 310 to the entire display area of the display panel 100. The light guiding plate 320 has a size and shape corresponding to the display panel 100, and is arranged in the rear side of the display panel 100.

In a lower side of the light guiding plate 320, a light guiding pattern or an optical pattern dispersing light may be provided to improve uniformity of light guided by the light guiding plate 320 and adjust the volume of transmitted light. That is, a brightness of the display area may depend upon the optical pattern.

At least one optical sheet 330 is provided between the display panel 100 and the light guiding plate 320 in parallel with the display panel 100. The optical sheet 330 includes at least one of a prism sheet, a diffusion sheet and a protection film, and transmits light guided by the light guiding plate 320 to the display panel 100.

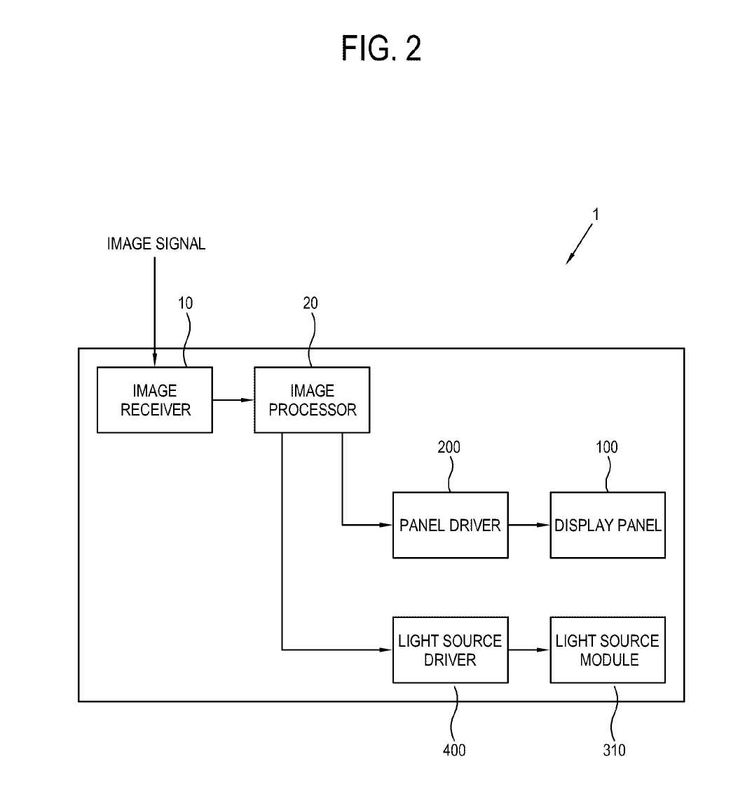

Hereinafter, a control configuration of the display apparatus 1 will be described with reference to FIG. 2. FIG. 2 is a block diagram of the display apparatus 1.

As shown therein, the display apparatus 1 includes an image receiver 10 which receives an image signal, an image processor 20 which processes an image signal received from the image receiver 10 to display an image, the display panel 100 which displays an image thereon, the panel driver 200 which drives the display panel 100 corresponding to the results of processing the image signal by the image processor 10, the light source module 310 which generates light, and the light source driver 400 that controls the light source module 310 corresponding to the results of processing the image signal by the image processor 20.

The light source driver 400 may be integrated with the light source substrate 317.

The image receiver 10 may correspond to image signals according to various standards. For example, the image receiver 10 may receive a radio frequency (RF) signal in a wireless manner from a broadcasting station (not shown), or receive an image signal according to at least one of composite video, component video, super video, SCART, and high definition multimedia interface (HDMI) standards. The image receiver 10 may receive an image signal according to D-SUB transmitting an RGB signal by VGA or digital video interactive (DVI) and HDMI standards.

The image processor 20 processes the image signal transmitted from the image receiver 10. The image processing by the image processor 20 includes, without limitation to, decoding and encoding for various image formats, deinterlacing, converting a frame refresh rate, scaling, reducing noise from an image for improving a picture quality, and enhancing details.

The image processor 20 may include individual configurations to perform each process individually, or include an integrated configuration to integrate several processes. The image processor 20 may be integrated to the panel driver 200, or installed in the same PCB as the panel driver 200.

The image processor 20 processes the image signal as described above, and controls the panel driver 200 and the light source driver 400 to drive the display panel 100 and the light source module 310, respectively, corresponding to the result. The panel driver 200 and the light source driver 400 control to rotate liquid crystals and generate light according to the processing result of the image processor 20, to thereby display an image on the display panel 100.

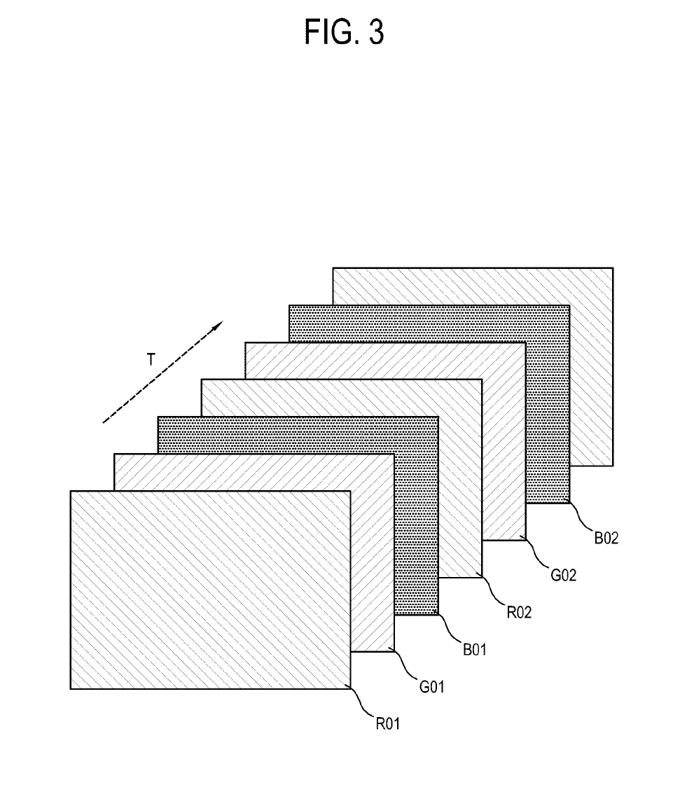

According to the present exemplary embodiment, the display panel 100 does not include a color filter, but a user recognizes a final color image as the display panel 100 sequentially displays an image corresponding to RGB colors. This will be described with reference to FIG. 3. FIG. 3 illustrates image fields R01, G01, B01, R02, G02 and B02 by light in RGB colors on a time basis in the display apparatus 1.

As shown therein, the image fields R01, G01, BO1, R02, G02 and B02 are sequentially displayed as time T elapses. The image field R01 corresponding to a red color, the image field G01 corresponding to a green color, and the image field B01 corresponding to a blue color are sequentially displayed, and a user views an image field in a final color that combines R01, G01 and B01 by recognizing R01, G01 and B01 overlapping each other.

According to the same principle, the image fields R02, G02 and B02 corresponding to the RGB colors are sequentially displayed, and a user may recognize a color image by the repetition of such processes.

To display the image field R01, the light source driver 400 turns on the red LED 311 among the red, green and blue LEDs 311, 313 and 315, and generates a red light from the light source module 310. The panel driver 200 controls the liquid crystals of the display panel 100 according to image data corresponding to the red color.

To display the image field G01, the light source driver 400 turns off the red LED 311, and turns on the green LED 313 to generate a green light from the light source module 310. The panel driver 200 controls the liquid crystals of the display panel 100 according to image data corresponding to the green color.

The display apparatus 1 according to the present exemplary embodiment may display a color image by the repetition of the above process.

In some cases, however, the display apparatus fixedly displays a first image for a long time. Hereinafter, for convenience of description, the expression “fixedly display” indicates that a location of the first image does not move substantially and the shape of the first image is not changed. Furthermore, hereinafter, for convenience of description, the expression “the first image” refers to an image that is fixedly displayed.

According to the present exemplary embodiment, the panel driver 200 sets a unit pixel group including a number of unit pixels (not shown) when driving the display panel 100 having a plurality of unit pixels, and sets the total number of the unit pixel groups to be different from the total number of pixels of the first image. The panel driver 200 selectively drives different unit pixels, through which light is transmitted, in a single unit pixel group as time elapses, and divides and applies a pixel value of the first image to the unit pixels through which light is transmitted.

Accordingly, liquid crystal stress of the display panel 100 is minimized, and an after image may be prevented, though a user may perceive the first image as if the first image is fixedly displayed.

Regarding the relationship between the total number of the unit pixel groups and the total number of pixels of the first image, the number of pixels in a single column of the first image is the same as the number of the unit pixels included in a single column of the display panel 100. Accordingly, the panel driver 200 sets the number of pixels of a horizontal resolution in the first image, i.e., the number of pixels in a single row of the first image, to be different from the number of the unit pixel groups of a single row of the display panel 100.

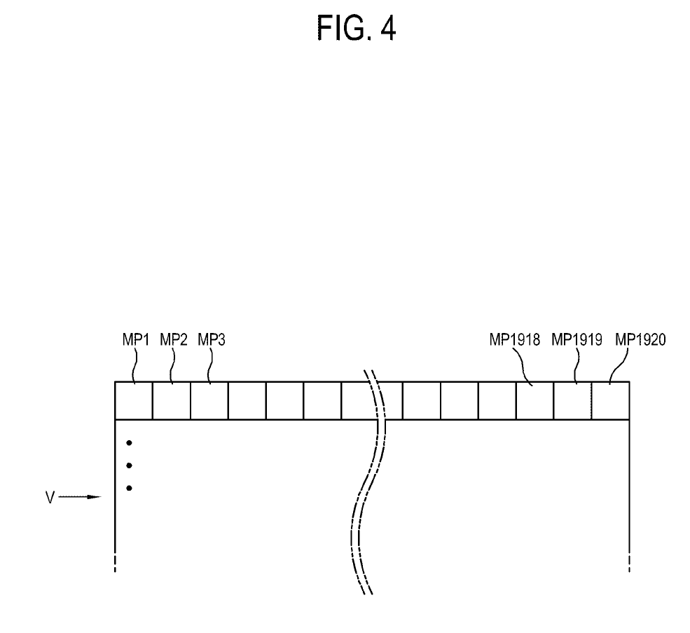

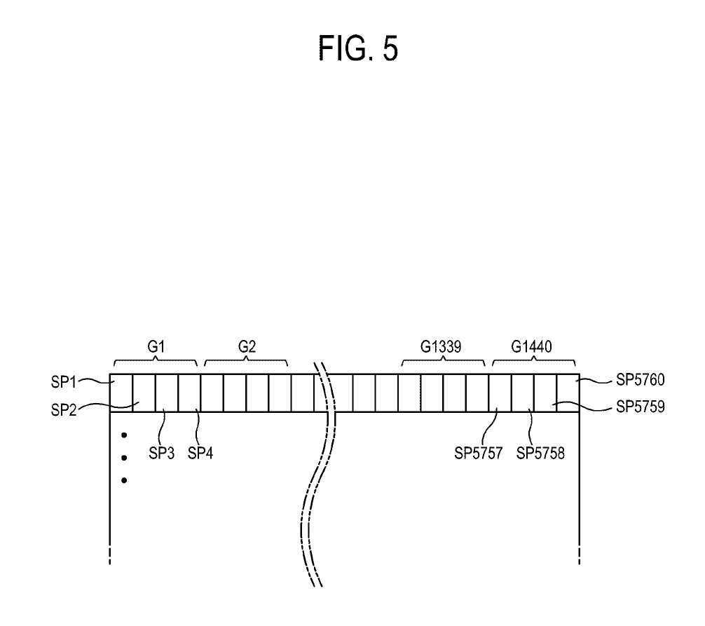

Hereinafter, a method of setting the unit pixel group by the panel driver 200 according to an exemplary embodiment will be described with reference to FIGS. 4 and 5.

FIG. 4 illustrates pixels MP1, MP2, MP3, MP1918, MP1919 and MP1920 forming a first image V.

As shown therein, the first image V includes a plurality of pixels MP1, MP2, MP3, MP1918, MP1919 and MP1920, and each of the pixels MP1, MP2, MP3, MP1918, MP1919 and MP1920 are arranged in a two-dimensional manner along a column and a row. FIG. 4 illustrates part of the pixels MP1, MP2, MP3, MP1918, MP1919 and MP1920 in the first row of the first image V.

For example, if a horizontal resolution of the first image V is 1920 pixels, then 1920 pixels MP1, MP2, MP3, MP1918, MP1919 and MP1920 are arranged in a single row of the first image V.

FIG. 5 illustrates a grouping of unit pixels SP1, SP2, SP3, SP4, SP5757, SP5758, SP5759 and SP5760 of the display panel 100.

As shown therein, the display panel 100 includes the plurality of unit pixels SP1, SP2, SP3, SP4, SP5757, SP5758, SP5759 and SP5760 arranged along a column and a row. FIG. 5 illustrates the unit pixels SP1, SP2, SP3, SP4, SP5757, SP5758, SP5759 and SP5760 of the first row of the display panel 100. For example, 5760 unit pixels SP1, SP2, SP3, SP4, SP5757, SP5758, SP5759 and SP5760 are arranged in a single row of the display panel 100 of FIG. 5. The number of the unit pixels SP1, SP2, SP3, SP4, SP5757, SP5758, SP5759 and SP5760 which are arranged in the single row of the display panel 100 may vary and does not limit the spirit of the present exemplary embodiment.

The panel driver 200 sets unit pixel groups G1, G2, G1339 and G1440 including the plurality of preset unit pixels SP1, SP2, SP3, SP4, SP5757, SP5758, SP5759 and SP5760. The number of the unit pixel groups G1, G2, G1339 and G1440 of a single row of the display panel 100 is set to be different from the number of pixels of the horizontal resolution of the first image V, and the number of the unit pixels SP1, SP2, SP3, SP4, SP5757, SP5758, SP5759 and SP5760 within the single unit pixel group G1, G2, G1339 and G1440 is adjusted properly corresponding to the number of the unit pixel groups. For example, if the number of the unit pixels SP1, SP2, SP3, SP4, SP5757, SP5758, SP5759 and SP5760 in a single row of the display panel 100 is 5760 pixels, and a horizontal resolution of the first image V is 1920 pixels, the number of the unit pixel groups G1, G2, G1339 and G1440 may be set as 1440 pixels. In this case, the single unit pixel group G1, G2, G1339 and G1440 includes four unit pixels SP1, SP2, SP3, SP4, SP5757, SP5758, SP5759 and SP5760.

The number of the unit pixel groups G1, G2, G1339 and G1440 and the number of unit pixels SP1, SP2, SP3, SP4, SP5757, SP5758, SP5759 and SP5760 belonging to the single unit pixel group G1, G2, G1339 and G1440 may vary depending on the design type, and does not limit the spirit of the present exemplary embodiment.

In the present exemplary embodiment, the panel driver 200 forms the unit pixel groups G1, G2, G1339 and G1440 by grouping the unit pixels SP1, SP2, SP3, SP4, SP5757, SP5758, SP5759 and SP5760 per four unit pixels in a single row. The unit pixel group G1 includes four unit pixels SP1, SP2, SP3 and SP4 which are adjacent to each other in a single row.

If the unit pixel groups G1, G2, G1339 and G1440 are set as above, the panel driver 200 selectively drives different unit pixels SP1, SP2, SP3, SP4, SP5757, SP5758, SP5759 and SP5760 through which light is transmitted, among those included in the respective unit pixel groups G1, G2, G1339 and G1440, as the unit time elapses. That is, the panel driver 200 shifts the unit pixels SP1, SP2, SP3, SP4, SP5757, SP5758, SP5759 and SP5760 through which light is transmitted, within the single unit pixel group G1, G2, G1339 and G1440.

The unit time may vary, e.g., may be applicable by field of the first image, frame of the first image, etc.

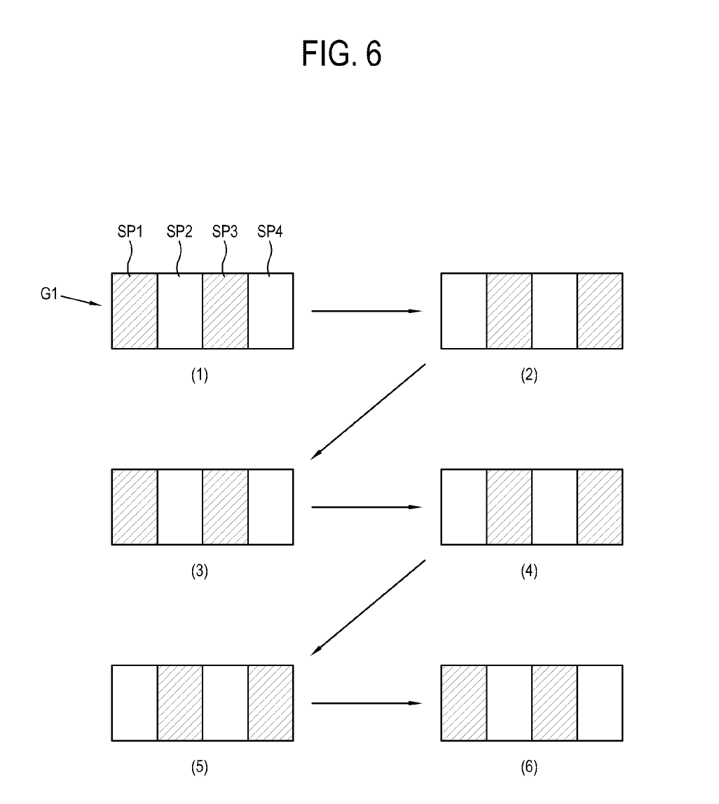

Hereinafter, a method of selectively driving the unit pixels SP1, SP2, SP3 and SP4 by the panel driver 200 will be described with reference to FIG. 6. FIG. 6 illustrates the method of driving the unit pixels SP1, SP2, SP3 and SP4 with respect to a single unit pixel group G1 in FIG. 5.

The present exemplary embodiment describes only the single unit pixel group G1, though it is understood that the description is applicable to the driving of other unit pixel groups G2, G1339 and G1440.

As shown in FIG. 6, the unit pixel group G1 includes four unit pixels SP1, SP2, SP3 and SP4. (1) to (6) in FIG. 6 indicate light transmittance stages of the unit pixels SP1, SP2, SP3 and SP4 as the unit time elapses. Hereinafter, hatched unit pixels refer to unit pixels SP1, SP2, SP3 and SP4 in a light transmittance state and unhatched unit pixels refer to unit pixels SP1, SP2, SP3 and SP4 in a non-light transmittance state.

In (1) in FIG. 6, the panel driver 200 classifies the unit pixels SP1, SP2, SP3 and SP4 within the unit pixel group G1 into two sub-groups, i.e., a first sub-group SP1 and SP3 and a second sub group SP2 and SP4. The panel driver 200 drives the first sub group SP1 and SP3 to transmit light therethrough, and operates so that the second sub group SP2 and SP4 does not transmit light therethrough.

The first sub group SP1 and SP3 and the second sub group SP2 and SP4 are termed for convenience in classifying the unit pixels SP1, SP2, SP3 and SP4 within the unit pixel group G1, and the term and number of the unit pixels SP1, SP2, SP3 and SP4 described herein does not limit the spirit of the present exemplary embodiment. The unit pixels SP1, SP2, SP3 and SP4 in the first sub group SP1 and SP3 and the second sub group SP2 and SP4 according to the present exemplary embodiment are alternately arranged, but the method of classifying the first sub group SP1 and SP3 and the second sub group SP2 and SP4 is not limited to the foregoing and may vary.

Meanwhile, the number of unit pixels SP1, SP2, SP3 and SP4 which belong to the first sub group SP1 and SP3 and the second sub group SP2 and SP4 is set equally, which will be described below.

In (2) in FIG. 6, the panel driver 200 operates so that the first sub group SP1 and SP3 does not transmit light therethrough, and drives the second sub groups SP2 and SP4 to transmit light therethrough.

In (3) in FIG. 6, the panel driver 200 drives the first sub group SP1 and SP3 to transmit light therethrough, and operates so that the second sub group SP2 and SP4 does not transmit light therethrough.

In (4) in FIG. 6, the panel driver 200 operates so that the first sub group SP1 and SP3 does not transmit light therethrough, and drives the second sub group SP2 and SP4 to transmit light therethrough.

As described above, the panel driver 200 alternately drives the first sub group SP1 and SP3 and the second sub group SP2 and SP4. As the light transmittance state of the particular unit pixels SP1, SP2, SP3 and SP4 is not fixed, liquid crystal stress is minimized while the first image V is displayed as if being fixed.

Accordingly, a user may recognize the first image V as if the image is fixedly displayed, and liquid crystal stress is minimized, thereby preventing an after image of the display panel 100.

The pixel value applied to the unit pixels SP1, SP2, SP3 and SP4 within the unit pixel group G1 will be described below.

In (5) in FIG. 6, the panel driver 200 operates so that the first sub group SP1 and SP3 does not transmit light therethrough, and drives the second sub group SP2 and SP4 to transmit light therethrough. In (6) in FIG. 6, the panel driver 200 drives the first sub group SP1 and SP3 to transmit light therethrough, and operates so that the second sub group SP2 and SP4 does not transmit light therethrough.

A selection pattern of the unit pixels SP1, SP2, SP3 and SP4 changes at the time between (4) and (5) in FIG. 6 to prevent liquid crystal stress due to a fixed pattern from occurring if the unit pixels SP1, SP2, SP3 and SP4 are selected to transmit light according to a preset pattern. Thus, the after image of the display panel 100 may be prevented by changing the selection pattern of the unit pixels SP1, SP2, SP3 and SP4 at preset intervals.

As compared to the present exemplary embodiment, the number of the unit pixels SP1, SP2, SP3 and SP4 included in the first sub group and the second sub group may differ, e.g., when the number of unit pixels of the first sub group is more than the number of unit pixels of the second sub group, according to another exemplary embodiment. In this case, the light transmittance by the first sub group generates higher brightness than that by the second sub group, and brightness becomes irregular over time while the first image V is displayed.

To prevent the above case, the number of the unit pixels SP1, SP2, SP3 and SP4 included in the first and second sub groups may be the same, though it is understood that another exemplary embodiment is not limited thereto. Furthermore, the number of the unit pixels SP1, SP2, SP3 and SP4 included in the single unit pixel group G1 may, although not necessarily, be even. If the number of the unit pixels included in the single unit pixel group is odd, the number of the unit pixels included in the first and second sub groups may not be the same.

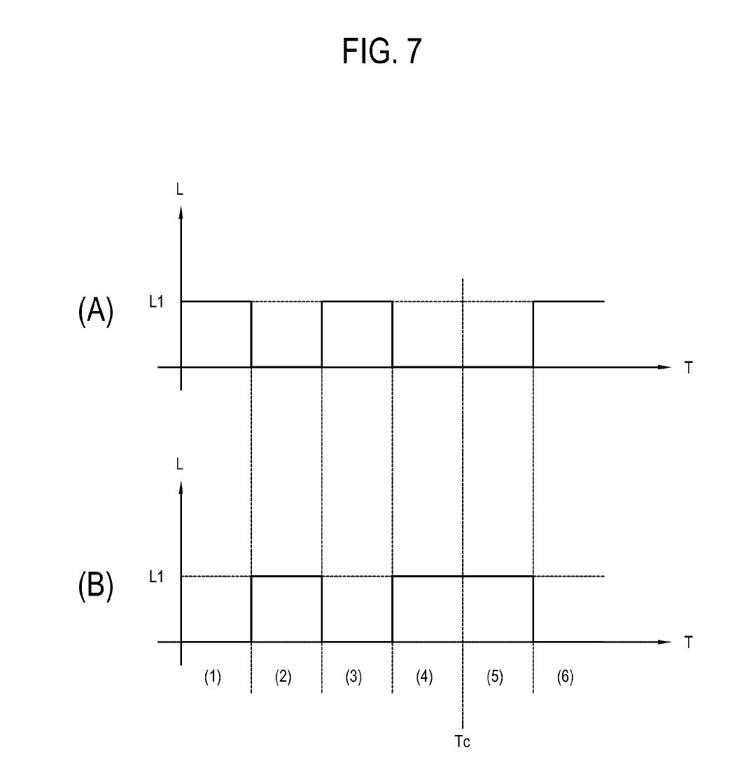

FIG. 7 is a graph which illustrates the driving method of the unit pixels SP1, SP2, SP3 and SP4 in FIG. 5 with respect to time.

As shown therein, a horizontal axis T of graphs (A) and (B) refers to time, and a vertical axis L refers to a digital brightness level. T and L are relative comparative values, and thus do not have any unit.

The graph (A) illustrates the case when the panel driver 200 controls the light transmittance of the first sub group SP1 and SP3, and the graph (B) illustrates the case when the panel driver 200 controls the light transmittance of the second sub group SP2 and SP4. In a vertical axis of the two graphs, L1 indicates a particular target digital brightness value.

According to the graphs (A) and (B), as time elapses from areas (1) to (4), the first sub group SP1 and SP3 and the second sub group SP2 and SP4 are turned on and off correspondingly to each other to transmit light therethrough. A timing Tc which is located between the area (4) and an area (5), refers to an interval at which the selection pattern of the unit pixels SP1, SP2, SP3 and SP4 changes as described above.

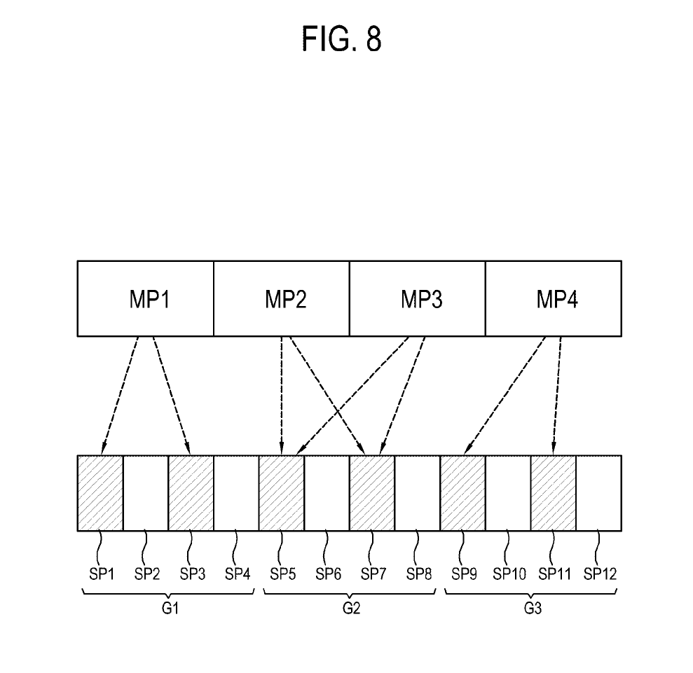

According to an exemplary embodiment, the number of pixels of the horizontal resolution of the first image V is set to be different from the number of the unit pixel groups in a single row of the display panel 100. Thus, regarding a pixel value which is applied to the unit pixel through which light is transmitted, the pixels of the first image and the unit pixels of the display panel 100 do not correspond in a 1:1 relationship. The pixel value of the first image V is divided and applied to the unit pixels, as will now be described with reference to FIG. 8. FIG. 8 illustrates a method of applying the pixel value to the unit pixels according to an exemplary embodiment.

As shown therein, if a horizontal resolution of the first image V is 1920 pixels and the number of unit pixel groups G1, G2, G1339 and G1440 in a single row of the display panel 100 is 1440 groups, three unit pixel groups G1, G2 and G3 adjacent to each other in the display panel 100 correspond to four adjacent pixels MP1, MP2, MP3 and MP4 of the first image V.

If light is transmitted by the unit pixels SP1, SP3, SP5, SP7, SP9 and SP 11 among the units pixels SP1, SP2, SP3, SP4, SP5, SP6, SP7, SP8, SP9, SP10, SP11 and SP12 of the unit pixel groups G1, G2 and G3, the pixel value of the pixels MP1, MP2, MP3 and MP4 of the first image V is divided and applied to the unit pixels SP1, SP3, SP5, SP7, SP9 and SP11.

That is, of four pixels MP1, MP2, MP3 and MP4 of the first image V, six unit pixels SP1, SP3, SP5, SP7, SP9 and SP 11 should receive the pixel value. Thus, the pixel values of the first image V should be divided to the unit pixels SP1, SP3, SP5, SP7, SP9 and SP 11 properly, which is called an interpolation.

For example, the panel driver 200 divides and applies the pixel value of the pixel MP1 to the unit pixels SP1 and SP3, and divides and applies the pixel value of the pixel MP4 to the unit pixels SP9 and SP11. In this case, the panel driver 200 calculates the average of the pixel values of the pixels MP2 and MP3 and applies the average pixel value to the unit pixels SP5 and SP7. By this method, the panel driver 200 may apply pixel values to the unit pixels SP1, SP2, SP3, SP4, SP5, SP6, SP7, SP8, SP9, SP10, SP11 and SP12.

The foregoing method is an exemplary embodiment, which does not limit the spirit of the present exemplary embodiment. By another method, the panel driver 200 may divide and apply the pixel value of the pixel MP1 to the unit pixels SP1 and SP3, divide and apply the pixel value of the pixel MP4 to the unit pixels SP9 and SP11, apply the pixel value of the pixel MP2 to the unit pixel SP5, and apply the pixel value of the pixel MP3 to the unit pixel SP7. Otherwise, the panel driver 200 may derive a change curve of the pixel value of the pixels MP1, MP2, MP3 and MP4, and then set the pixel value to be similar to the derived change curve to apply the pixel value to the unit pixels SP1, SP3, SP5, SP7, SP9 and SP11.

Moreover, though FIG. 7 illustrates a change of a degree of light transmittance of the unit pixels SP1, SP2, SP3 and SP4 by the panel driver 200 by turning on and off the unit pixels SP1, SP2, SP3 and SP4 on a time basis, it is understood that the spirit of the present exemplary embodiment is not limited thereto, and various driving controls are possible.

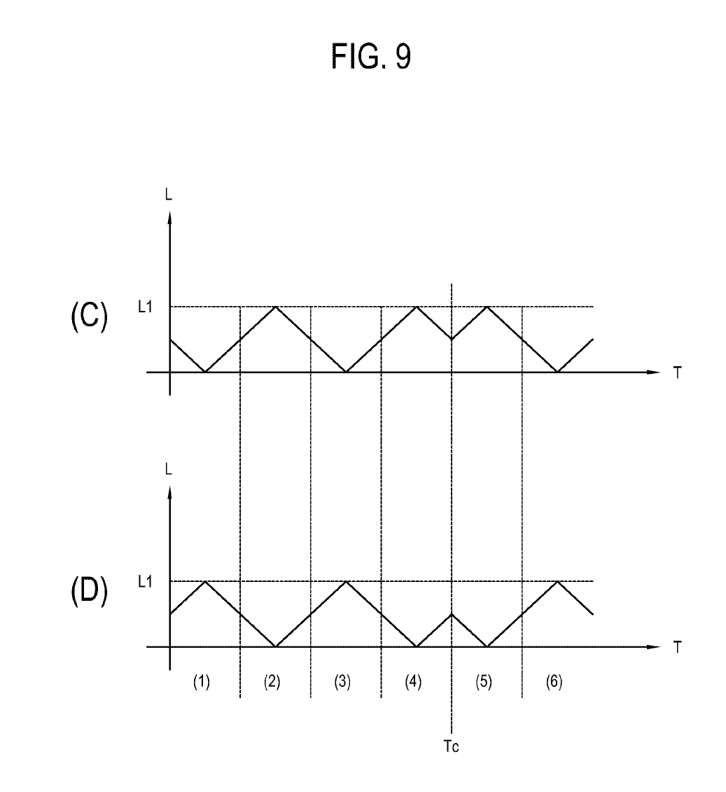

FIG. 9 is a graph which illustrates a driving method of unit pixels SP1, SP2, SP3 and SP4 with respect to time according to a second exemplary embodiment.

A graph (C) in FIG. 9 illustrates the case when the panel driver 200 controls the light transmittance of the first sub group SP1 and SP3, and a graph (D) illustrates the case when the panel driver 200 controls the light transmittance of the second sub group SP2 and SP4. Other matters including horizontal and vertical axes are the same as those in FIG. 7.

According to the second exemplary embodiment, the panel driver 200 changes the degree of light transmittance of the unit pixels SP1, SP2, SP3 and SP4 linearly on a time basis.

For example, in an area (1), the panel driver 200 decreases the degree of light transmittance of the first sub group SP1 and SP3 linearly and then increases the light transmittance linearly again after a light blocking operation. The panel driver 200 increases the degree of light transmittance of the second sub group SP2 and SP4 linearly and then decreases the light transmittance linearly after reaching a preset level L1.

In an area (2), the panel driver 200 increases the degree of light transmittance of the first sub group SP1 and SP3 linearly, and then decreases the degree of light transmittance again linearly after reaching a level L1. The panel driver 200 also decreases the degree of light transmittance of the second sub group SP2 and SP4 linearly and then increases the degree of light transmittance again linearly after the light blocking.

Even if the degree of light transmittance of the first sub group SP1 and SP3 and the second sub group SP2 and SP4 changes on a time basis, the total brightness value at the predetermined timing is still the same, i.e., L1. As time elapses, the entire brightness of the first image V may be uniform.

To change the selection pattern of the unit pixels SP1, SP2, SP3 and SP4 at the timing Tc, the panel driver 200, in an area (5), increases the degree of light transmittance of the first sub group SP1 and SP3 which was decreasing, and decreases the degree of light transmittance of the second sub group SP2 and SP4 which was increasing. The panel driver 200, in an area (6), decreases the degree of light transmittance of the first sub group SP1 and SP3 linearly and then increases again the degree of light transmittance linearly, and increases the degree of light transmittance of the second sub group SP2 and SP4 linearly and then decreases the degree of light transmittance linearly after reaching the preset level L1.

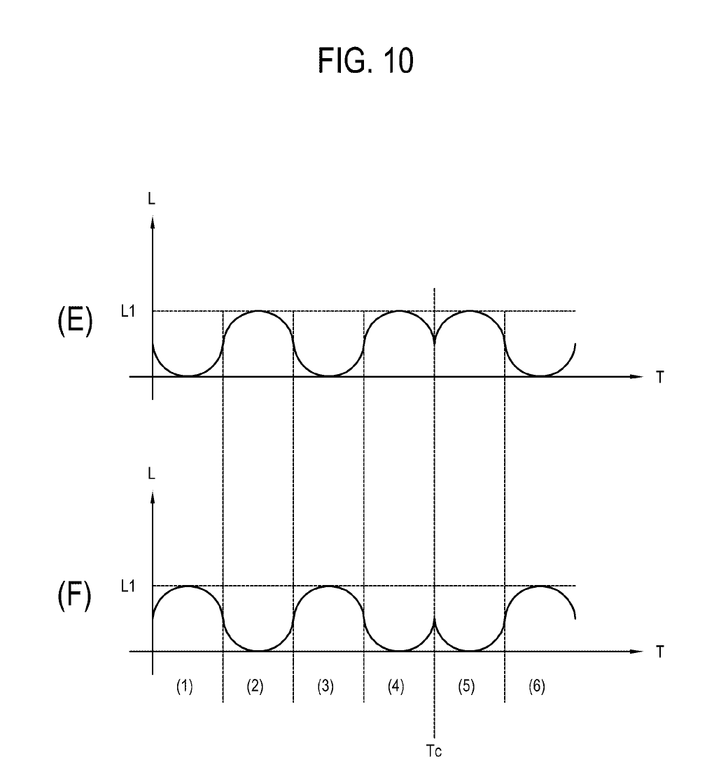

FIG. 10 is a graph which illustrates a driving method of unit pixels SP1, SP2, SP3 and SP4 with respect to time according to a third exemplary embodiment.

A graph (E) in FIG. 10 illustrates the case when the panel driver 200 controls the light transmittance of the first sub group SP1 and SP3, and a graph (F) illustrates the case when the panel driver 200 controls the light transmittance of the second sub group SP2 and SP4. Other matters including horizontal and vertical axes are the same as those in FIG. 7.

According to the third exemplary embodiment, the panel driver 200 changes a degree of light transmittance of unit pixels SP1, SP2, SP3 and SP4 on a time basis in a non-linear type, e.g., in a sine wave.

For example, in an area (1), the panel driver 200 decreases the degree of light transmittance of the first sub group SP1 and SP3 in a non-linear manner and then increases the degree of light transmittance non-linearly after the light blocking operation, and increases the degree of light transmittance of the second sub group SP2 and SP4 in a non-linear manner and then decreases the degree of light transmittance non-linearly after the level L1.

Meanwhile, in an area (2), the panel driver 200 increases the degree of light transmittance of the first sub group SP1 and SP3 in a non-linear manner in an area (2) and then decreases the degree of light transmittance non-linearly after the level 1, and decreases the degree of light transmittance of the second sub group SP2 and SP4 in a non-linear manner and then increases the degree of light transmittance non-linearly after the light blocking.

Even if the light transmittance of the first sub group SP1 and SP3 and the second sub group SP2 and SP4 changes on a time basis, the total brightness value at the predetermined timing is still the same, i.e., L1. As time elapses, the entire brightness of the first image V may be uniform.

To change the selection pattern of the unit pixels SP1, SP2, SP3 and SP4 at the timing Tc, the panel driver 200, in an area (5), increases the degree of light transmittance of the first sub group SP1 and SP3, which was decreasing, in a non-linear manner, and decreases the degree of light transmittance of the second sub group SP2 and SP4, which was increasing, in a non-linear manner. The panel driver 200, in an area (6), decreases the degree of light transmittance of the first sub group SP1 and SP3 in a non-linear manner and then increases again the degree of light transmittance in the non-linear manner, and increases the degree of light transmittance of the second sub group SP2 and SP4 in a non-linear manner and then decreases the degree of light transmittance in the non-linear manner after reaching the preset level L1.

As described above, the method of changing the degree of light transmittance of the unit pixels SP1, SP2, SP3 and SP4 by the panel driver 200 may vary according to exemplary embodiments.

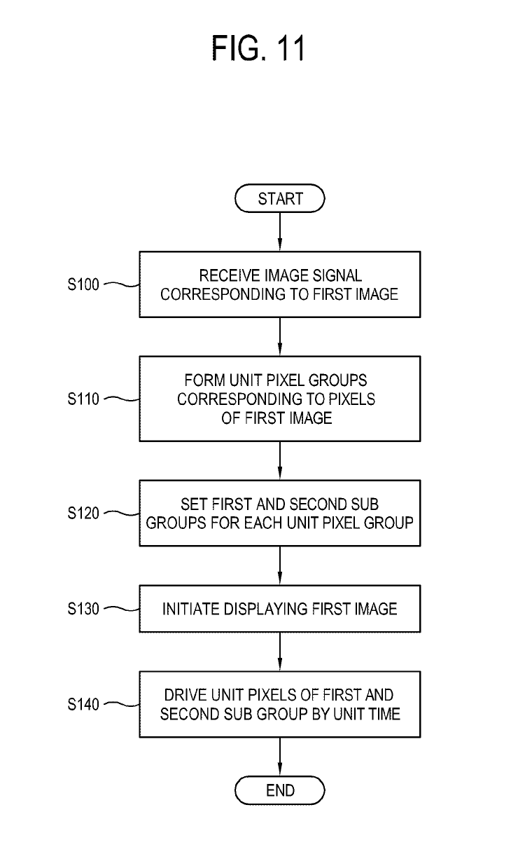

FIG. 11 is a control flowchart of a driving method of the display panel 100 according to a fourth exemplary embodiment.

The detailed configuration of the display apparatus 1 according to the fourth exemplary embodiment is substantially the same as that according to the first exemplary embodiment, and descriptions of the same configurations will be omitted herein.

As shown in FIG. 11, according to the present exemplary embodiment, if an image signal corresponding to the first image V is received by the display apparatus 1 (operation S100), the panel driver 200 forms the unit pixel groups G1, G2, G1339 and G1440 corresponding to pixels MP1, MP2, MP3, MP1338, MP1339 and MP1440 (operation S110).

The panel driver 200 sets the first sub group SP1 and SP4 and the second sub group SP2 and SP4 for each of the unit pixel groups G1, G2, G1339 and G1440 (operation S120).

As the display of the first image V is initiated (operation S130), the panel driver 200 selectively, e.g., alternately, drives the unit pixels SP1, SP2, SP3 and SP4 of the first sub group SP1 and SP3 and the second sub group SP2 and SP4 by unit time (operation S140), thereby displaying the first image V.

Accordingly, if the first image V is fixedly displayed, liquid crystal stress is minimized and the after image may be prevented.

While not restricted thereto, an exemplary embodiment can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs. Moreover, one or more units of the display apparatus 100 can include a processor or microprocessor executing a computer program stored in a computer-readable medium.

Although a few exemplary embodiments have been shown and described, it will be appreciated by those skilled in the art that changes may be made in these exemplary embodiments without departing from the principles and spirit of the inventive concept, the scope of which is defined in the appended claims and their equivalents.

What is claimed is:

1. A display apparatus comprising:
a backlight unit which generates and emits light;
a display panel which comprises a plurality of unit pixels, and displays a first image using the light emitted by the backlight unit; and
a panel driver which sets a total number of unit pixel groups comprising a preset number of unit pixels, from among the plurality of unit pixels, to be different from a total number of pixels of the first image, and selectively drives different unit pixels of a unit pixel group among the total number of unit pixel groups, at different times, to transmit the light therethrough.

2. The display apparatus according to claim 1, wherein the panel driver sets a number of pixels of a horizontal resolution of the first image to be different from a number of unit pixel groups in a single row of the display panel.

3. The display apparatus according to claim 2, wherein the panel driver divides and applies a pixel value of the first image to a unit pixel, of the unit pixel group, through which the light is transmitted.

4. The display apparatus according to claim 1, wherein the preset number of unit pixels of the unit pixel group is even.

5. The display apparatus according to claim 4, wherein the unit pixel group comprises a first sub group and a second sub group, and a number of unit pixels in the first sub group is equal to a number of unit pixels in the second sub group.

6. The display apparatus according to claim 5, wherein the panel driver alternately drives the first sub group and the second sub group to transmit the light therethrough.

7. The display apparatus according to claim 1, wherein the panel driver selects the different unit pixels, through which the light is transmitted, by field or frame of the first image.

8. The display apparatus according to claim 7, wherein the panel driver changes a degree of light transmittance of the unit pixels by turning on and off the unit pixels, linearly or non-linearly, on a unit time basis.

9. The display apparatus according to claim 1, wherein the panel driver selects the different unit pixels, through which the light is transmitted, for every unit time according to a preset pattern, and changes the preset pattern at a preset interval.

10. The display apparatus according to claim 1, wherein the display panel does not include a color filter, and the backlight unit sequentially supplies light in red, green and blue colors to the display panel.

11. The display apparatus according to claim 2, wherein the panel driver calculates an average pixel value of first and second pixels of the first image, and applies the calculated average pixel value to a unit pixel, of the unit pixel group, through which the light is transmitted.

12. The display apparatus according to claim 2, wherein the panel driver applies a pixel value of the first image to a unit pixel, of the unit pixel group, through which the light is transmitted.

13. A driving method of a display panel, the driving method comprising:
receiving an image signal corresponding to a first image;
setting a total number of unit pixel groups comprising a preset number of unit pixels, from among a plurality of unit pixels of the display panel, to be different from a total number of pixels of the first image; and
selectively driving different unit pixels of a unit pixel group among the total number of unit pixel groups, at different times, to transmit light therethrough to display the first image.

14. The driving method according to claim 13, wherein the setting the unit pixel group comprises setting a number of pixels of a horizontal resolution of the first image to be different from a number of unit pixel groups in a single row of the display panel.

15. The driving method according to claim 14, wherein the selectively driving the different unit pixels comprises dividing and applying a pixel value of the first image to a unit pixel, of the unit pixel group, through which the light is transmitted.

16. The driving method according to claim 13, wherein the preset number of unit pixels of the unit pixel group is even.

17. The driving method according to claim 16, wherein the unit pixel group comprises a first sub group and a second sub group, and a number of unit pixels in the first sub group is equal to a number of unit pixels in the second subgroup.

18. The driving method according to claim 17, wherein the selectively driving the different unit pixels comprises alternately driving the first sub group and the second sub group to transmit the light therethrough.

19. The driving method according to claim 13, wherein the selectively driving the different unit pixels comprises selecting the different unit pixels, through which light is transmitted, by field or frame of the first image.

20. The driving method according to claim 19, wherein the selectively driving the different unit pixels comprises changing a degree of light transmittance of the unit pixels by turning on and off the unit pixels, linearly or non-linearly, on a unit time basis.

21. The driving method according to claim 13, wherein the selectively driving the different unit pixels comprises selecting the different unit pixels, through which the light is transmitted, for every unit time according to a preset pattern, and changing the preset pattern at a preset interval.
